(19) United States
(12) Patent Application Publication
(10) Pub. No.: US 2010/0197293 A1
(43) Pub. Date: Aug. 5, 2010

(54) REMOTE COMPUTER ACCESS AUTHENTICATION USING A MOBILE DEVICE

(75) Inventor: Yuval Shem-Tov, Ramat Gan (IL)

Correspondence Address: SUGHRUE MION, PLLC, 2100 PENNSYLVANIA AVENUE, N.W., SUITE 800, WASHINGTON, DC, 20037, US

(73) Assignee: A.D.V. COMMUNICATIONS LTD., Ramat Gan (IL)

(21) Appl. No.: 12/679,422

(22) PCT Filed: Sep. 17, 2008
(86) PCT No.: PCT/IL08/01246

§ 371 Date: Mar. 22, 2010

Related U.S. Application Data
(60) Provisional application No. 60/994,949, filed on Sep. 20, 2007.

(51) Int. Cl. H04W 4/00

(52) U.S. Cl. 455/420

(57) ABSTRACT

A method for establishing access to a computer (42) includes receiving an incoming call in a call receipt device (30), the incoming call having been placed by a caller over a telephone network (58) from a mobile device (56) to a telephone number that is associated with the computer. The caller is authenticated automatically responsively to the incoming call. Upon authenticating the caller, the caller is permitted to remotely access the computer via a data network.

### CROSS-REFERENCE TO RELATED APPLICATION

This application claims the benefit of U.S. Provisional Patent Application 60/994,949 filed Sep. 20, 2007, whose disclosure is incorporated herein by reference.

### FIELD OF THE INVENTION

The present invention relates generally to remote computer access, and specifically to authentication for desktop virtualization using a mobile device.

### BACKGROUND OF THE INVENTION

Desktop Virtualization is used to provide a remote user with access to a computer when the remote user resides in a separate physical location from the computer. The computer is typically located at home, at the office or in a data center. The remote user is typically located elsewhere. He or she may be traveling and may need to connect to the computer from a hotel room, an airport or from a different city. In contrast, a local computer user accesses a desktop operating system directly and physically accesses the peripheral components associated with the computer. Typically, the local computer user uses a local keyboard, an operation device, and monitor hardware.

When a computer desktop is virtualized, its keyboard, mouse and video display, along with any other peripheral components, are typically redirected across a network via a remote desktop protocol. Some examples of remote desktop protocols include Remote Desktop Protocol (RDP), Independent Computing Architecture (ICA), and Virtual Network Computing (VNC).

### SUMMARY OF THE INVENTION

An embodiment of the present invention provides a method for establishing access to a computer, including receiving an incoming call in a call receipt device, the incoming call having been placed by a caller over a telephone network from a mobile device to a telephone number that is associated with the computer. The caller is authenticated automatically responsively to the incoming call. Upon authenticating the caller, the caller is permitted to remotely access the computer via a data network.

In some embodiments, receiving the incoming call includes receiving a short message service (SMS) message or receiving a voice call. Authenticating the caller may include authenticating the caller on the computer responsively to a caller identification conveyed by the incoming call. In one embodiment, receiving the incoming call includes receiving in the call receipt device an indication of a telephone number from which the call was placed, and authenticating the caller includes comparing the telephone number to a list of authorized telephone numbers.

In some embodiments, authenticating the caller includes generating a temporary remote access code, sending a first message via the telephone network containing the temporary remote access code to the caller, and receiving, responsively to the first message, a second message from the caller containing the temporary remote access code. Additionally or alternatively, authenticating the caller includes checking at least one call parameter selected from a group consisting of an allowed access time window and an allowed geographical area from which the incoming call originated, and permitting the caller to access the computer includes allowing access only if the at least one call parameter is within a predefined range.

There is also provided, in accordance with an embodiment of the present invention, a computer access authentication system, including a call receipt device having an assigned telephone number and being adapted to receive an incoming call via a telephone network placed by a caller to the assigned telephone number. A computer is linked to the call receipt device and includes a network interface to a data network and a processor, which is operative to authenticate the caller responsively to the incoming call, and upon authenticating the caller, to permit the caller to remotely access the computer via the data network.

There is additionally provided, in accordance with an embodiment of the present invention, a computer software product for establishing access to a computer, including a computer-readable medium in which program instructions are stored, which instructions, when executed by a computer, cause the computer to receive an indication of an incoming call via a call receipt device, the call having been placed by a caller over a telephone network from a mobile device to a telephone number that is associated with the computer, to automatically authenticate the caller responsively to the incoming call, and upon authenticating the caller, to permit the caller to remotely access the computer via a data network.

The present invention will be more fully understood from the following detailed description of the embodiments thereof, taken together with the drawings, in which:

### BRIEF DESCRIPTION OF THE DRAWINGS

For a better understanding of the present invention, reference is made to the detailed description of the invention, by way of example, which is to be read in conjunction with the following drawings, wherein like elements are given like reference numerals, and wherein:

FIG. 1 is a block diagram that schematically illustrates a remote computer access authentication system, in accordance with an embodiment of the present invention;

FIG. 2 is a flow chart that schematically illustrates a remote computer access authentication method, in accordance with an embodiment of the present invention;

FIG. 3 is a detailed flow chart of a remote computer access authentication method, in accordance with a disclosed embodiment of the present invention;

FIG. 4 is a flow chart of a remote computer access authentication method, in accordance with an alternate embodiment of the present invention;

FIG. 5 is a flow chart of a remote computer access authentication method, in accordance with an alternate embodiment of the present invention;

FIG. 6 is a flow chart of a remote computer startup and shutdown method, in accordance with an alternate embodiment of the present invention; and

FIG. 7 is a block diagram that schematically illustrates a remote computer access authentication system, in accordance with an alternate embodiment of the present invention.

### DETAILED DESCRIPTION OF EMBODIMENTS

### Overview

Desktop virtualization typically separates the physical location where the PC desktop environment resides from where a user is accessing the PC. Benefits include improved security provided by storing servers in secure data centers, lowered management costs through centralization, and effectively shared computing power across many users.

Providing PC desktop functionality to users across various networks raises a number of security risks. The primary security risk in this sort of use model is due to the need for a computer to wait for a connection attempt from a remote user. While the computer is in an online listening mode, it has to respond to any login attempt. Login attempts may be malicious, which makes the computer vulnerable to unauthorized access.

Embodiments of the present invention provide methods and systems for enhancing the security of remotely accessed computers. The computer connects to a wide-area network (WAN) only when an authorized remote user needs access. The computer is connected to a call receipt device that can receive telephone calls and uses these calls to authenticate the remote user before opening a WAN connection for the remote user.

In some embodiments, the remote user calls a telephone number associated with the computer and sends an initial message, typically using a mobile telephone or other mobile telephone network device. The call placed by the remote user may be a messaging call or a voice call. The computer authenticates the remote user using an access application, which implements several security features, disclosed below.

After remote user identity is verified, the computer is connected to the WAN. Access is provided to the remote user through a specific address that is unique to an authorized session, and only for the duration of the authorized session. The call receipt device typically transmits a connection message from a wireless transceiver to the telephone network device associated with the remote user, containing the specific IP address associated with the computer. The connection message may also include an assigned port number.

The now-authenticated remote user accesses the computer using a terminal via the WAN, completes any login operations, and uses the computer. The remote user may disconnect the computer from the WAN while using the terminal, or by making another call to send another message requesting that the access application disconnect the computer from the WAN. Alternatively, the computer may be automatically disconnected from the WAN if no remote user activity is detected for a disconnection time interval.

Using a caller identification, which is a secure identifier that relies upon the security provided by the mobile phone network, ensures accurate identification of the remote user. Connecting the computer to the WAN only when the remote user needs to use the computer minimizes vulnerability to unauthorized access. Additional security options are described hereinbelow in the section entitled “Security.”

### System Architecture

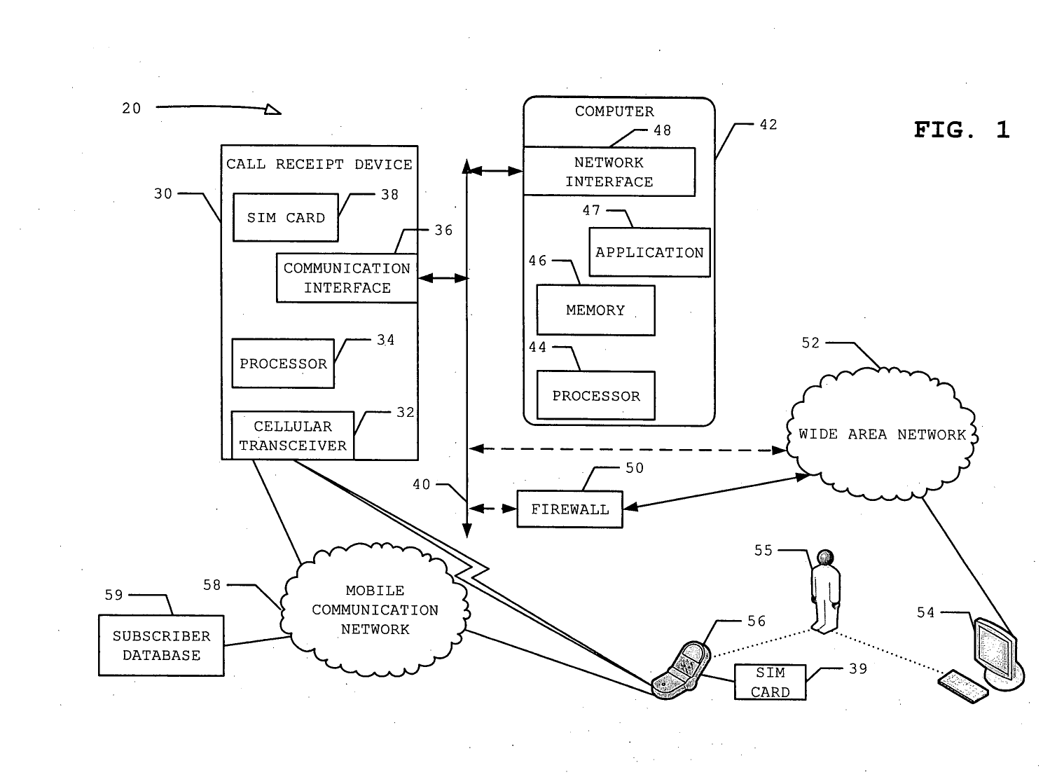

Reference is now made to FIG. 1, which is a block diagram showing a computer access authentication system 20, in accordance with an embodiment of the present invention. A remote user 55 wishes to connect a terminal 54 to a computer 42 across a wide-area network (WAN) 52, such as the Internet. Computer 42 may comprise any computer system that is known in the art, and may include a processor 44, a memory 46, an access application 47 and a network interface 48. In the context of the patent application and claims, the remote user or caller is referred to simply as the “remote user.”

Terminal 54 typically comprises a personal computer with a suitable connection to WAN 52. In the context of the patent application and claims, the term “terminal” denotes any suitable computing device, either fixed or mobile, so long as the computing device has facilities for accessing WAN 52.

Computer 42 is connected to a call receipt device 30, which comprises a cellular transceiver 32, a processor 34, a communication interface 36, and a subscriber identity module (SIM), which is realized as a SIM card 38. Device 30 may comprise, for example, a cellular telephone or a cellular data modem. A mobile device 56 also comprises a SIM card 39 which is substantially similar to SIM card 38, and is associated with the telephone number of remote user 55. Cellular transceiver 32 is typically a wireless modem (which may be of the standard type that is part of any modern cellular telephone), but may comprise any type of device that is able to send and to receive messaging and voice calls over any type of phone network including mobile networks and fixed lines. Communication interface 36 may comprise a Bluetooth® adapter, an Infrared Data Association (IrDA) device, a cable connection, or any communication interface that is known to those skilled in the art and which allows call receipt device 30 to communicate with computer 42.

In an embodiment of the present invention, a bus 40 connects call receipt device 30, computer 42, WAN 52, and a hardware firewall 50 (optional). Bus 40 may be any conventional bus or connector. In some embodiments, firewall 50 is connected to a local area network (not shown). In alternative embodiments, call receipt device 30 is connected to a USB port (not shown) on computer 42. Numerous other connectivity configurations known to those skilled in the art may be utilized to connect call receipt device 30, computer 42, firewall 50 and WAN 52.

In embodiments in which it is present, firewall 50 monitors and controls communication between computer 42 and WAN 52. Firewall 50 may control port access, application permissions, and communication protocols as described hereinbelow. Firewall 50 may run on separate hardware as illustrated in FIG. 1 or may comprise a software application running on computer 42.

Processor 44 connects computer 42 to WAN 52 so that computer 42 is accessible via WAN 52. Connectivity may be provided using any method known in the art. For example, access application 47 may enable a Local Area Connection, thereby connecting computer 42 and WAN 52.

Remote user 55 may connect terminal 54 to computer 42 via WAN 52 using any remote computer access software known in the art. A suitable remote computer access program is Virtual Network Computing (VNC), an open-source graphical desktop sharing system.

Processor 44 typically comprises a general-purpose computer processor, which is programmed in software to carry out the functions that are described herein. The software may be downloaded to processor 44 in electronic form, over a network, for example. Alternatively or additionally, the software may be provided on tangible media, such as optical, magnetic, or electronic storage media. Further alternatively, at least some of the functions of processor 44 may be carried out by dedicated or programmable hardware.

### System Administration

Access application 47 is typically used to configure computer access and remote user security settings, under local or remote control of a system administrator. In the latter case, remote user 55 may be the system administrator, who, upon initiation of a session with computer 42, can invoke access application 47 and modify the current configuration. In one example, access application 47 is used to configure a list of valid operation requests which may be sent by remote user 55 to call receipt device 30 using mobile device 56.

In another example, the system administrator uses access application 47 to manage a list of authorized mobile device numbers. Additionally or alternatively, the system administrator may use access application 47 to configure a remote access timeout interval, to limit the amount of time that the caller has to respond with the received remote access code.

In yet another example, the system administrator configures access application 47 to require additional verification tests for remote user 55 to pass in order to obtain access to computer 42. Each verification test comprises checking at least one call parameter by processor 44. One verification test comprises determining whether remote user 55 is attempting to access computer 42 during an allowed access time window configured by the system administrator. Processor 44 checks a call time parameter, comparing the call time parameter with the allowed access time window. Another verification test comprises determining whether remote user 55 is calling from an allowed geographical area configured by the system administrator. Processor 44 checks a call origination area parameter, comparing the call origination area parameter with the allowed geographical area based, for example, on the identification of the network in which the call originated. Those skilled in the art will understand that the system administrator may configure other verification tests. The example verification tests described herein are provided for the purpose of illustration.

In another example, the system administrator uses access application 47 to configure an assigned password for remote user 55, to be entered by the remote user when connecting to the computer using the terminal. While only one remote user is shown in FIG. 1, system 20 is capable of accommodating multiple remote users sequentially or concurrently.

In yet another example, the system administrator invokes access application 47 to associate a port number with remote user 55. An associated port number may be provided to remote user 55 to use when connecting to computer 42, as described hereinbelow. The associated port number is typically used to provide additional security, particularly when multiple users access computer 42.

In one example, the system administrator invokes access application 47 to configure a temporary remote access code for a recipient. The temporary remote access code may be sent by computer 42 to remote user 55 or to the system administrator via WAN 52 during a remote user authentication process as described hereinbelow in the Security section. When the recipient of the temporary remote access code is the system administrator, he is required to personally authenticate remote user 55 by replying with the temporary remote access code.

The system administrator may use access application 47 to turn off some or all of the security features. As a result, computer access authentication system 20 may provide faster access to computer 42 for remote user 55. The lowered access time is achieved with an attendant decrease in security for protecting computer 42.

### EMBODIMENT 1

Access application 47 typically runs continuously on computer 42, as a service on Microsoft Windows© operating systems (OS), or as a daemon on UNIX© OS, for example. While in standby mode, access application 47 awaits an indication from call receipt device 30 that a call is received in order to authenticate remote user 55.

Remote user 55 uses mobile device 56 to contact call receipt device 30 in order to initiate a remote computing session on computer 42 using terminal 54. Remote user 55 contacts call receipt device 30 by calling a telephone number associated with call receipt device 30 and computer 42 via a mobile communication network 58. The associated telephone number is uniquely associated with computer 42 by virtue of the linkage between computer 42, call receipt device 30 and SIM card 38. In the context of the patent application and claims, the term “call” is used broadly to include both voice calls and messaging calls. In the context of the patent application and claims, the term “messaging call” denotes a text or data message received by call receipt device 30 from mobile device 56, such as a Short Message Service (SMS) call.

When a connection is established between mobile device 56 and call receipt device 30, processor 34 receives a remote user identifier, such as the caller identification provided by SIM card 39. The caller identification typically comprises a caller telephone number. Processor 34 passes the caller identification to computer 42 via bus 40, whereupon processor 44 verifies the identity of remote user 55 by analyzing the caller identification, typically by invoking access application 47. Processor 44 instructs call receipt device 30 to terminate the call if remote user 55 is not authorized to connect to computer 42.

Upon placing the call, remote user 55 sends an initial message to call receipt device 30 using mobile device 56. The initial message may be, for example, an SMS message, comprising an operation request to perform a computer connection operation, connecting computer 42 to WAN 52.

Processor 44 invokes access application 47 to authenticate remote user 55, typically by checking whether the caller identification, sent by remote user 55 using mobile device 56 to call receipt device 30, is included in the list of authorized mobile device numbers. Once processor 44 authenticates remote user 55, processor 44 instructs call receipt device 30 to send a connection message to mobile device 56. The connection message is usually a Universal Resource Locator (URL) indicating a protocol that should be used for the connection, such as Hypertext Transfer Protocol (HTTP), and an Internet Protocol (IP) address to which remote user 55 should connect. In some cases, the associated port number is added by processor 44 to the IP address provided to remote user 55 in the connection message. Alternatively, the IP address and other connection parameters may be pre-assigned, so that no connection message is required, with the possible exception of an acknowledgment that the remote user has been authenticated.

Processor 44 invokes access application 47 to connect computer 42 to WAN 52, thereby making computer 42 reachable by remote user 55 at the IP address provided to remote user 55 in the connection message sent by call receipt device 30 or otherwise assigned for this purpose. Remote user 55 uses the IP address to connect terminal 54 to computer 42. Typically, remote user 55 uses remote computer access software, such as the above-noted VNC program, to connect terminal 54 to computer 42, and then he uses computer 42 remotely. When remote user 55 is finished using computer 42, remote user 55 indicates a termination of the current session to computer 42 or to call receipt device 30, as described hereinbelow, thereby causing computer 42 to disconnect from WAN 52. Access application 47 then returns to standby mode to await a new call indication.

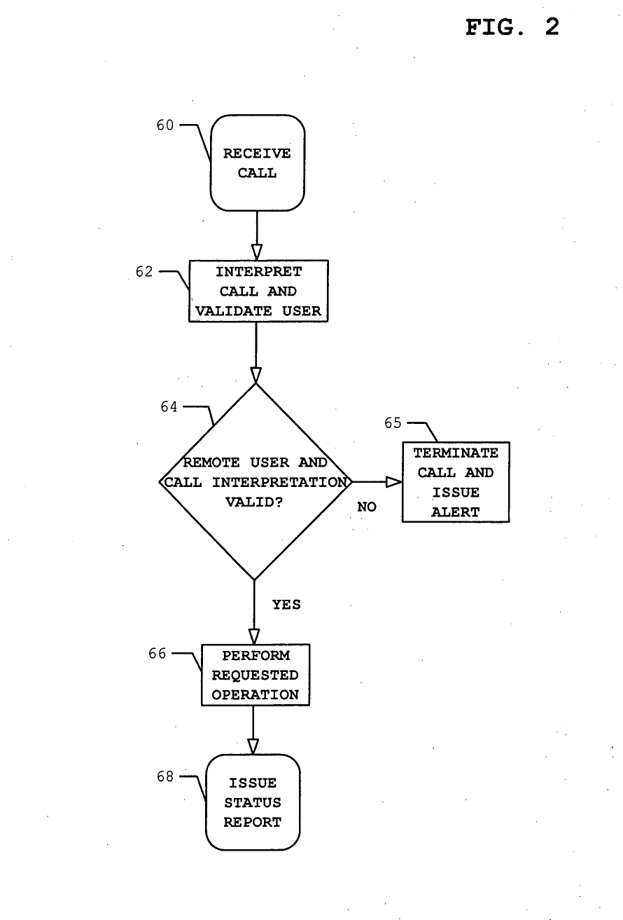

Reference is now made to FIG. 2, which is a flow chart that schematically illustrates a method of computer access authentication, in accordance with an embodiment of the present invention. In a call receiving step 60, call receipt device 30 receives the call as discussed above with reference to FIG. 1.

In a validation step 62, processor 44 interprets the call and validates remote user 55. Although processor 44 interprets the call and validates remote user 55 in this embodiment, other elements in computer access authentication system 20 could be assigned the function of interpreting the call and validating remote user 55. For example, processor 34 could also interpret the call and validate remote user 55.

Processor 44 interprets the call and identifies the operation request in the messaging call or the voice call. Processor 44 decides whether remote user 55 is valid and whether the call contains a valid operation request in a remote user and call interpretation validity decision step 64. In the present embodiment, processor 44 verifies the identity of remote user 55 by analyzing the caller identification as described hereinabove. Additionally or alternatively, the processor may require additional means of verification, such as entry of a username and password, as described hereinbelow. If processor 44 decides that either remote user 55 or the call interpretation is invalid, processor 44 terminates the call and sends an alert message to the system administrator, in a call termination and alert issuing step 65.

The alert message is typically an SMS message, whereby processor 44 causes cellular transceiver 32 to send the SMS message to the system administrator, usually by invoking access application 47. Although processor 44 causes cellular transceiver 32 to send the SMS message in this embodiment, other elements in computer access authentication system 20 could be assigned this task. For example, processor 34 could also cause cellular transceiver 32 to send the SMS message to the system administrator.

If remote user 55 and the call interpretation are successfully validated at step 64, processor 44 performs the operation request sent by remote user 55 in a requested operation performing step 66. The operation request may be either the computer connection operation described hereinabove with reference to FIG. 1, or a request to start up or to shut down computer 42. The computer connection operation may comprise connecting computer 42 to WAN 52 or disconnecting computer 42 from WAN 52.

In a status report issuing step 68, processor 44 may issue a status report to remote user 55. The status report is typically a status response message sent by processor 44 to confirm performance of the operation request. Optionally, the status report is also sent to the system administrator.

### Modes of Operation

In one mode of operation, call receipt device 30 and computer 42 use Interactive Voice Response (IVR) in authenticating remote user 55 over a voice call, instead of or in addition to the SMS-based authentication method described above. Typically, the IVR functions are carried out by suitable software running on computer 42, which transmits synthesized voice requests to remote user 55 via call receipt device 30. Utilization of an IVR system (not shown explicitly in the figures) enables computer 42 to detect voice communication and touch tones received from remote user 55 during the call. Remote user 55 may use his voice to communicate with call receipt device 30 by means of the IVR system. Additionally or alternatively, remote user 55 may communicate with call receipt device 30 using non-vocal input devices, e.g., a keypad on mobile device 56.

In another mode of operation, multiple remote users may be provided with concurrent access to computer 42. They are provided with different associated port numbers for use when accessing computer 42 as described hereinabove in the System Administration section.

In yet another mode of operation, computer 42 has a pre-assigned URL or other address. (As noted in the System Administration section, access application 47 may be used to turn off some or all of the security features.) When the address of computer 42 is known in advance, remote user 55 may connect to computer 42 immediately after being authenticated, once computer 42 is connected to WAN 52.

### Security

Referring again to FIG. 1, computer access authentication system 20 provides security for computer 42 by keeping computer 42 disconnected from network 52 until computer 42 receives and authenticates the call from remote user 55. Computer access authentication system 20 relies upon the security features of mobile communication network 58 for authentication as described hereinbelow. Furthermore, access application 47 provides additional security options.

Mobile communication network 58 includes an automatic subscriber identification facility that authenticates each call made by mobile device 56. Each SIM card 38, 39 contains a secret key, called a “Ki,” used to validate each SIM card's identity to mobile communication network 58 in order to prevent theft of services. The Ki is typically a 128-bit secret key. Each SIM card 38, 39 stores a unique Ki assigned to it by a mobile device operator during a personalization process. The mobile device operator also stores the Ki in a subscriber database 59, typically referred to as a home location register.

Elements of mobile communication network 58 authenticate SIM card 38 or 39 conventionally by consulting a “home” mobile device company. In brief, the home mobile device company is the mobile device operator associated with SIM card 38, 39, and has a copy of the Ki. The home mobile device company authenticates each SIM card 38, 39 that attempts to connect to mobile communication network 58, typically when mobile device 56 is powered on. Authentication is usually accomplished without transmitting the Ki directly. An encryption key is generated that is subsequently used to encrypt all communication with mobile communication network 58, including messaging and voice calls.

When remote user 55 places the call as discussed above with reference to FIG. 1, mobile communication network 58 generates the caller identification based on a conventional authentication process. Protection from security breaches is guaranteed by using the caller identification as the secure identifier, and by relying upon mobile communication network 58 for security. Mobile communication network 58 authentication for mobile device utilization is considered to be virtually invulnerable to attacks employing available computing capabilities.

Security is also provided by separating the telephone number associated with computer 42 from terminal 54. An unauthorized person would require the associated telephone number in addition to the caller identification in order to access computer 42. When the system administrator configures access application 47 to require additional verification tests, processor 44 verifies that remote user 55 passes each verification test, by checking the call parameters as described hereinabove, before allowing remote user 55 to connect to computer 42.

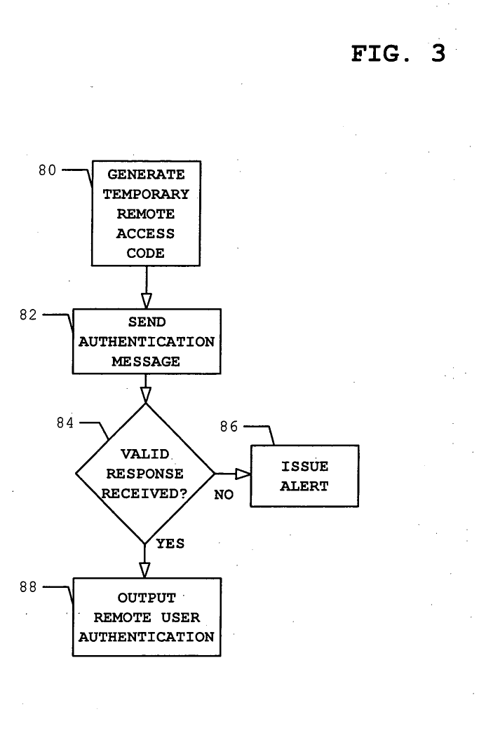

Reference is now made to FIG. 3, which is a flow chart that schematically illustrates a remote user authentication process that is applicable to several disclosed embodiments of the present invention. In order to authenticate remote user 55, processor 44 invokes access application 47 to generate the temporary remote access code, in a temporary remote access code generating step 80. The temporary remote access code expires after the above-noted remote access timeout interval. The system administrator configures the remote access timeout interval as described hereinabove.

In an authentication message sending step 82, processor 44 sends the temporary remote access code, typically in the form of a SMS message to mobile device 56 via call receipt device 30. Remote user 55 is required to respond by sending the temporary remote access code back to call receipt device 30 by directing mobile device 56 to communicate an authentication response message, typically in the form of a SMS message. Alternatively, remote user 55 may be authenticated by entering the temporary remote access code into terminal 54 when logging into computer 42. If call receipt device 30 fails to receive the authentication response message from caller 55 by the end of the remote access timeout interval, in a valid response receiving determination step 84, processor 44 deems remote user 55 to be invalid.

Alternatively, if call receipt device 30 receives the authentication response message from remote user 55 using mobile device 56, processor 44 ascertains whether the code contained in the authentication response message matches the temporary remote access code. If the authentication response message matches the temporary remote access code, processor 44 deems remote user 55 to be valid. In other words, receipt of a valid copy of the temporary remote access code in a same or different format from remote user 55 proves that the initial message was sent from remote user 55 using mobile device 56.

When remote user 55 fails to respond with a valid authentication response message, processor 44 issues an alert message to the system administrator, in an alert issuing step 86. In an output step 88, processor 44 outputs an authentication result. cl EMBODIMENT 2

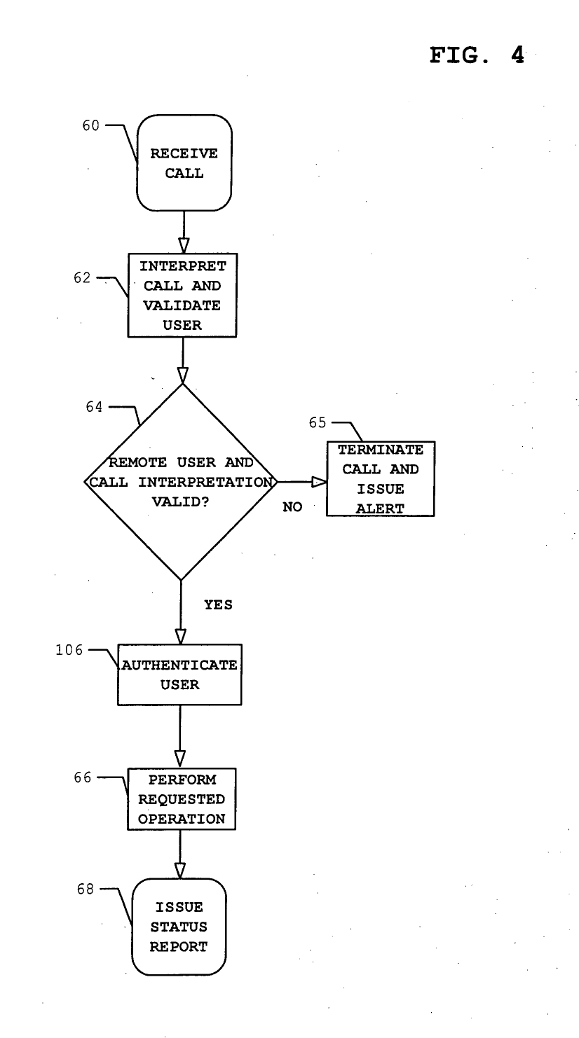

Reference is now made to FIG. 4, which is a flow chart that schematically illustrates a remote computer access authentication method, in accordance with an alternate embodiment of the present invention. The method is similar to the method of FIG. 2, except as described below.

After performing steps 60, 62, and 64, processor 44 authenticates remote user 55 in a user authenticating step 106. It is assumed that processor 44 has decided that remote user 55 is valid and the call contains a valid operation request in step 64.

User authenticating step 106 is performed using a temporary remote access code according to the method described above in FIG. 3. It is assumed that processor 44 deems user 55 to be valid in valid response receiving determination step 84 (FIG. 3). Steps 66 and 68 are performed as described hereinabove.

### EMBODIMENT 3

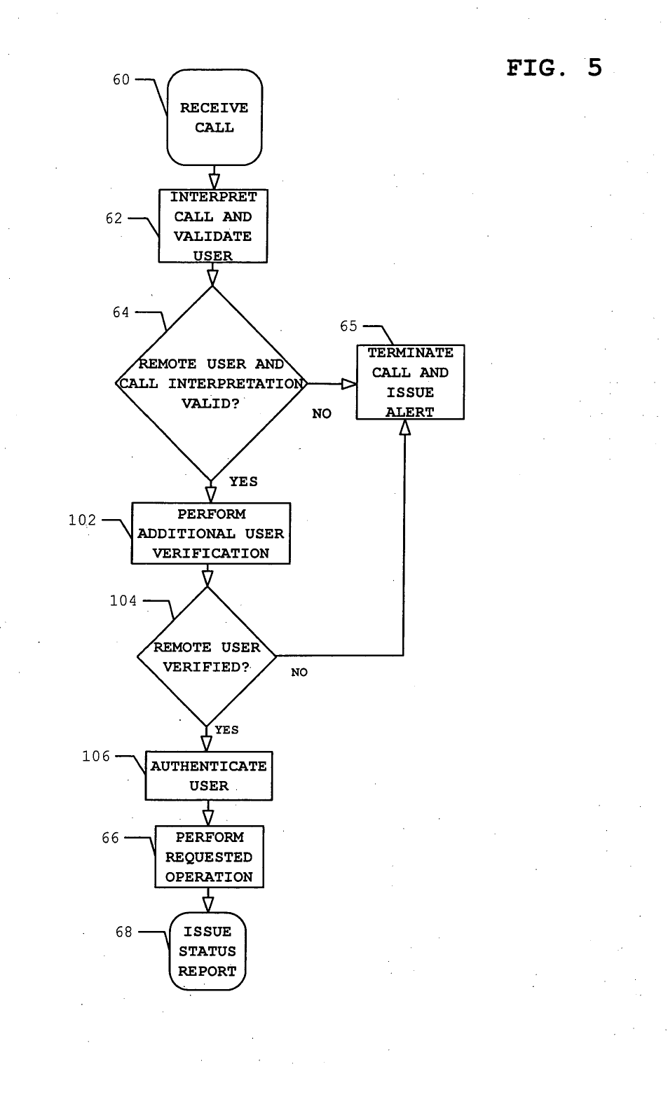

Reference is now made to FIG. 5, which is a flow chart that schematically illustrates a remote computer access authentication method, in accordance with an alternate embodiment of the present invention. The method is similar to the method of FIG. 4, except as described below.

After performing steps 60, 62, and 64, processor 44 performs additional verification tests configured by the system administrator as described hereinabove, in an additional user verification test performing step 102. Several example verification tests are described hereinabove in the System Administration section. However, other authentication tests will occur to those skilled in the art and may additionally or alternatively be performed to verify remote user 55.

Processor 44 decides whether remote user 55 has passed each additional user verification test in a remote user verifying decision step 104, by checking each call parameter. If processor 44 decides that remote user 55 has failed any of the additional user verification tests, processor 44 terminates the call and sends an alert message to the system administrator, in call termination and alert issuing step 65.

If remote user 55 passes each additional user verification test, remote user 55 is authenticated in user authenticating step 106, as described hereinabove. It is assumed that processor 44 deems user 55 to be valid in valid response receiving determination step 84 (FIG. 3). Steps 66 and 68 are performed as described hereinabove.

### EMBODIMENT 4

Referring again to FIG. 2, there are a number of ways to configure computer 42 for connection to and disconnection from WAN 52.

In one technique, processor 44 connects computer 42 to WAN 52 using firewall 50 to open physical ports or sockets in network interface 48 for communication between computer 42 and WAN 52. (A socket is a logical combination of the IP address and the port number.) A software program such as SmoothWall©, an open-source product, may be used to open all ports or sockets in another technique. However, if the administrator has configured the associated port number for remote user 55, processor 44 opens only the associated port number. In some techniques, processor 44 uses firewall 50 to open virtual ports or sockets in network interface 48.

In another technique, a local area connection is enabled to connect computer 42 to WAN 52 in a Microsoft Windows operating system environment. In an alternative technique, a routing table is refreshed to provide connectivity between computer 42 and WAN 52. The routing table is typically stored in memory 46 and comprises routes to specific network destinations.

Processor 44 may perform any technique described herein to connect computer 42 to WAN 52 independently of or in tandem with another technique. The connection technique is not critical, and any suitable technique or combination of techniques known in the art may be employed, so long as the authentication requirements described herein are met.

Processor 42 performs a corresponding disconnection procedure when the computer connection operation comprises disconnecting computer 42 from WAN 52. For example, when the local area network (not shown) is used to establish the connection, the local area connection may be disabled. Those skilled in the art will understand that processor 44 is not limited to the techniques described herein, and may disconnect computer 42 from WAN 52 by any suitable technique known in the art.

### EMBODIMENT 5

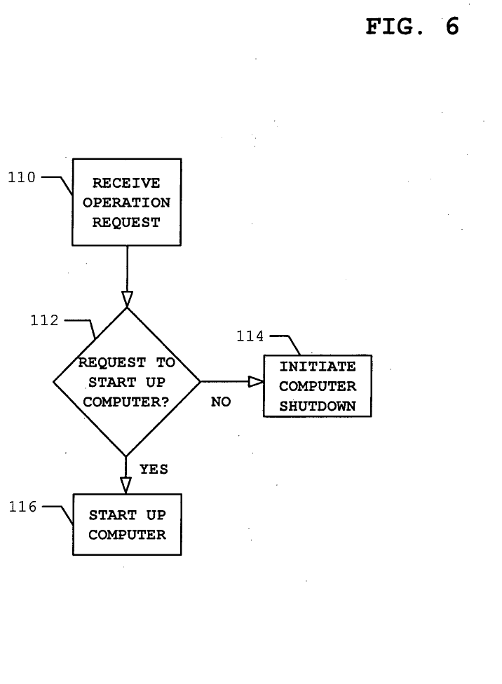

Reference is now made to FIG. 6, which is a flow chart that schematically illustrates a remote computer startup and shutdown method, in accordance with an alternate embodiment of the present invention. The requested operation performed in step 66 (FIG. 2) may comprise the request to startup or to shutdown computer 42.

In an operation request receiving step 110, processor 44 receives the operation request from remote user 55 to start up or to shut down computer 42. Processor 44 decides whether the operation request is to start up or to shut down computer 42 in a computer startup requesting decision step 112. If processor 44 decides that the operation request is to shut down computer 42, processor 44 initiates a computer shutdown process on computer 42 in a computer shutdown initiating step 114.

### EMBODIMENT 6

With continued reference to FIG. 1, in an alternate embodiment of the present invention, call receipt device 30 is connected to a computer power supply (not shown) on computer 42. If processor 44 decides that the operation request is to start up computer 42, call receipt device 30 starts computer 42 in a computer startup step 116. Alternatively, the call receipt device may wake the computer from a hibernation or standby state.

### EMBODIMENT 7

With continued reference to FIG. 1, in an alternate embodiment of the present invention, computer 42 is connected to a home electronic device via a local area network (wired or wireless, not shown). Remote user 55 contacts call receipt device 30 with the operation request to start up computer 42. Computer 42 starts up, simultaneously activating the home electronic device. At a different time, remote user 55 may contact call receipt device 30 with the operation request to shutdown computer 42. Computer 42 shuts down, simultaneously deactivating the home electronic device. Alternatively, the computer may power up and shut down home electronic devices, under control of the remote user, while the computer itself remains powered up.

### EMBODIMENT 8

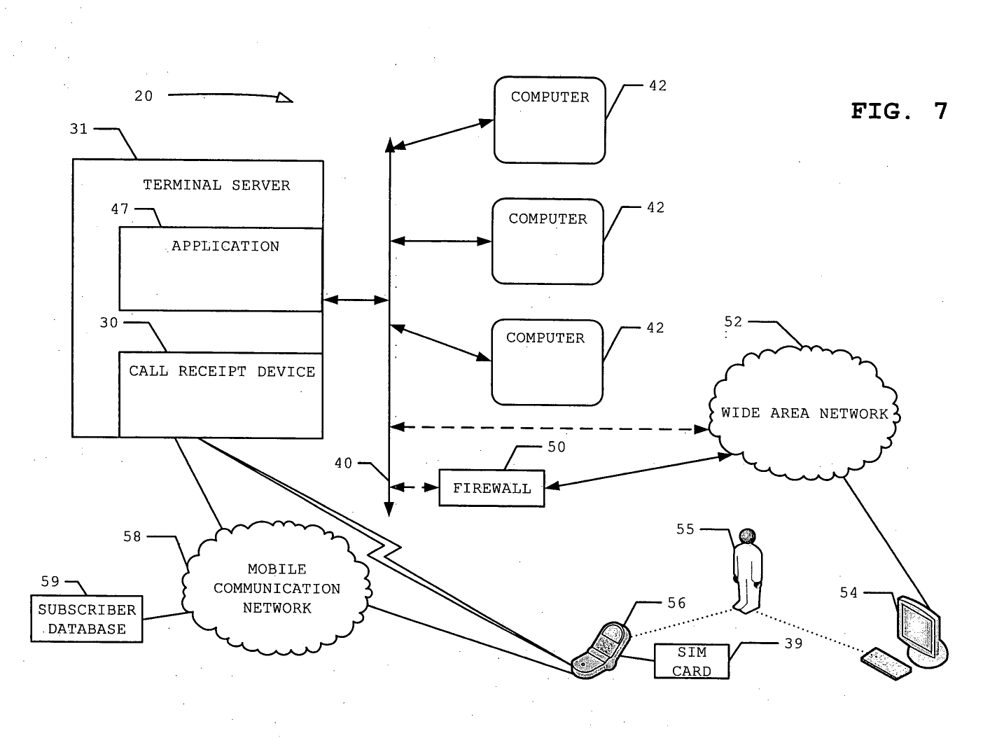

Reference is now made to FIG. 7, which is a block diagram that schematically illustrates a remote computer access authentication system, in accordance with an alternate embodiment of the present invention. The diagram is similar to the diagram of FIG. 1, except as described below.

In the embodiment of FIG. 7, call receipt device 30 and access application 47 are installed on a terminal server 31. Typically, terminal server 31 provides a Microsoft Windows or UNIX operating system desktop to multiple user terminals.

Terminal server 31 may use access application 47 to authenticate multiple users as described hereinabove in the System Administration section. After authentication, terminal server 31 typically connects remote user 55 to one of a multiplicity of computers 42. The terminal server may allocate and open a different port for each authenticated user.

It will be appreciated by persons skilled in the art that embodiments of the present invention are not limited to what has been particularly shown and described hereinabove. Rather, the scope of the present invention includes both combinations and sub-combinations of the various features described hereinabove, as well as variations and modifications thereof that are not in the prior art, which would occur to persons skilled in the art upon reading the foregoing description.

1. A method for establishing access to a computer, comprising:
receiving an incoming call in a call receipt device, the incoming call having been placed by a caller over a telephone network from a mobile device to a telephone number that is associated with the computer;
automatically authenticating the caller responsively to the incoming call; and
upon authenticating the caller, permitting the caller to remotely access the computer via a data network.

2. The method according to claim 1, wherein receiving the incoming call comprises receiving a short message service (SMS) message.

3. The method according to claim 1, wherein receiving the incoming call comprises receiving a voice call.

4. The method according to claim 1, wherein authenticating the caller comprises authenticating the caller on the computer responsively to a caller identification conveyed by the incoming call.

5. The method according to claim 4, wherein receiving the incoming call comprises receiving in the call receipt device an indication of a telephone number from which the call was placed, and wherein authenticating the caller comprises comparing the telephone number to a list of authorized telephone numbers.

6. The method according to claim 1, wherein authenticating the caller comprises generating a temporary remote access code, sending a first message via the telephone network containing the temporary remote access code to the caller, and receiving, responsively to the first message, a second message from the caller containing the temporary remote access code.

7. The method according to claim 1, wherein authenticating the caller comprises checking at least one call parameter selected from a group consisting of an allowed access time window and an allowed geographical area from which the incoming call originated, and wherein permitting the caller to access the computer comprises allowing access only if the at least one call parameter is within a predefined range.

8. A computer access authentication system, comprising:
a call receipt device having an assigned telephone number and being adapted to receive an incoming call via a telephone network placed by a caller to the assigned telephone number; and
a computer, which is linked to the call receipt device and comprises a network interface to a data network and a processor, which is operative to authenticate the caller responsively to the incoming call, and upon authenticating the caller, to permit the caller to remotely access the computer via the data network.

9. The computer access authentication system according to claim 8, wherein the incoming call is a short message service (SMS) message.

10. The computer access authentication system according to claim 8, wherein the incoming call comprises a voice call.

11. The computer access authentication system according to claim 8, wherein in authenticating the caller, the computer is operative to authenticate the caller on the computer responsively to a caller identification conveyed by the incoming call.

12. The computer access authentication system according to claim 11, wherein the call receipt device receives an indication of a telephone number from which the call was placed, and wherein in authenticating the caller, the computer is operative to compare the telephone number to a list of authorized telephone numbers.

13. The computer access authentication system according to claim 8, further comprising a subscriber identity module, wherein in authenticating the caller, the computer is operative to generate a temporary remote access code, to send a first message via the telephone network using the subscriber identity module containing the temporary remote access code to the caller, and to receive, responsively to the first message, a second message from the caller containing the temporary remote access code.

14. The computer access authentication system according to claim 8, wherein in authenticating the caller, the computer is operative to check at least one call parameter, selected from a group consisting of an allowed access time window and an allowed geographical area from which the incoming call originated, and to permit the caller to access the computer by allowing access only if the at least one call parameter is within a predefined range.

15. A computer software product for establishing access to a computer, comprising a computer-readable medium in which program instructions are stored, which instructions, when executed by a computer, cause the computer to receive an indication of an incoming call via a call receipt device, the call having been placed by a caller over a telephone network from a mobile device to a telephone number that is associated with the computer, to automatically authenticate the caller responsively to the incoming call, and upon authenticating the caller, to permit the caller to remotely access the computer via a data network.

16. The product according to claim 15, wherein the incoming call comprises a short message service (SMS) message.

17. The product according to claim 15, wherein the incoming call comprises a voice call.

18. The product according to claim 15, wherein the instructions cause the computer to authenticate the caller on the computer responsively to a caller identification conveyed by the incoming call.

19. The product according to claim 18, wherein the instructions cause the computer to receive in the call receipt device an indication of a telephone number from which the call was placed, and to authenticate the caller by comparing the telephone number to a list of authorized telephone numbers.

20. The product according to claim 15, wherein the instructions cause the computer to authenticate the caller by generating a temporary remote access code, to send a first message via the telephone network containing the temporary remote access code to the caller, and to receive, responsively to the first message, a second message from the caller containing the temporary remote access code.
